(19) United States
(12) Patent Application Publication
(10) Pub. No.: US 2009/0211390 A1
(43) Pub. Date: Aug. 27, 2009

(54) Joint For Industrial Robots

(76) Inventors: Torgny Brogardh, Vasteras (SE); Ove Kullborg, Vasteras (SE); Ove Ode, Vasteras (SE)

Correspondence Address: ST. ONGE STEWARD JOHNSTON & REENS, LLC, 986 BEDFORD STREET, STAMFORD, CT, 06905-5619, US

(21) Appl. No.: 12/437,147

(22) Filed: May 7, 2009

Related U.S. Application Data
(63) Continuation of application No. PCT/EP2007/061962, filed on Nov. 7, 2007.
(60) Provisional application No. 60/857,482, filed on Nov. 8, 2006.

(51) Int. Cl. B25J 17/00; F16C 11/06

(52) U.S. Cl. 74/490.03; 403/138; 74/490.05; 901/28; 901/23

(57) ABSTRACT

The invention relates to a joint having a male unit and a female unit. The external surface of the male unit is of complementary shape to the internal surface of the female unit. The units cooperate and have shapes allowing rotational movement in at least one degree of freedom of the male unit within the female unit. The female unit has two socket parts. According to the invention biasing means is provided for biasing each of the socket parts towards the male unit.

### CROSS-REFERENCE TO RELATED APPLICATIONS

The present application is a continuation of pending International patent application PCT/EP2007/061962 filed on Nov. 7, 2007 which designates the United States and claims priority from U.S. provisional patent application 60/857,482 filed on Nov. 8, 2006, the content of which is incorporated herein by reference.

### FIELD OF THE INVENTION

The present invention relates to a joint comprising a male unit and a female unit, the external surface of the male unit being of complementary shape to the internal surface of the female unit for cooperation therewith and having a shape allowing rotational movement in at least one degree of freedom of the male unit within the female unit, the female unit comprising at least two socket parts.

### BACKGROUND OF THE INVENTION

In order to transmit forces between two relative each other movable objects a link with a joint in each end is needed. One important application for this kind of transmission is parallel kinematics robots with six links, where the links transmit forces between actuators and a platform.

Extremely important for the performance of a parallel kinematics robot is the stiffness of the link transmissions. It is also important that the mass of the moving parts is as small as possible. The reason for this is that a robot with low inertia and high stiffness will have a high mechanical bandwidth, which is very important for high motion control performance.

Since the rods in the links of a parallel kinematics robot designed for just axial forces in the links (and no bending or twisting torques) only need to transmit axial forces these can be made very stiff and still lightweight, for example by using large diameter carbon tubes. However, using joints built up from ball- or roller bearings gives high weight relative stiffness. For example, a joint with the stiffness of about 50 Newton/micron will have a weight of 0.8 kg using high stiffness ball bearings, which means about 60 Newton/micron, kg. Thus, joints with higher stiffness pro kg is very much needed since high weight of the moving parts of the robot means low natural frequencies and constraints in robot performance.

The object of the present invention therefore is to provide a joint of the kind in question with high stiffness in relation to its weight.

### SUMMARY OF THE INVENTION

The object of the invention is achieved in that a joint of the kind in question comprises the specific features that biasing means is provided for biasing each of the socket parts towards the male unit.

Since the socket parts through the biasing means are clamped towards the male unit it is attained that the contact force between the male and the female units will be distributed on the complete contact surface. Thereby the surface pressure conditions become more favourable in comparison with a ball- or cylinder bearing. The result is that the joint becomes much more stiff for a given dimension. By the arrangement of clamping the socket parts the joint will have a high stiffness in relation to its weight.

In relation to other ball- and socket bearings the arrangement with having at least two socket parts pre-stressed against the male unit makes it possible to obtain large interface surfaces simultaneously with large angular working ranges for the joint.

According to a preferred embodiment the biasing means comprises a mechanical spring arrangement.

This results in a simple and reliable construction. The spring material can be steel plastic or rubber dependent on the application.

According to a further preferred embodiment the spring arrangement is acting between a spring retainer device and a first of the socket parts, the spring retainer device being connected to the second socket part.

Thereby one single spring arrangement will perform the biasing force on both of the socket parts, which further makes the construction simple and contributes to a low weight. The spring retainer is very important in order to obtain an easy to assemble joint.

According to a further preferred embodiment the spring retainer device is connected to the second socket part by a screw joint.

Thereby the spring force can be easily adjusted. Assembly and disassembly also becomes easy.

According to a further preferred embodiment the screw joint includes an external thread on one of the socket parts and matching internal thread on the other socket part.

This will still further simplify the assembly of the joint since only one screwing action is required. Furthermore, the screw joint thereby automatically will result in a homogeneous force distribution in the circumferential direction, which assures a proper function of the joint. Furthermore this makes it possible to make a screw with smaller screw pitch.

According to a further preferred embodiment a shim is located between the spring retainer device and the second socket part.

This offers a simple possibility to adjust the spring force by exchanging the shim.

According to a further preferred embodiment the first socket part acts as a thrust washer for the spring arrangement.

The thrust washer will assure that the springs will be kept in place, and using the socket part as the thrust washer reduces the number of parts in the joint, which leads to a more simple construction and lower weight.

According to a further preferred embodiment the male unit has a rotation symmetrical external surface which is generated by a curved line

The joint thereby will have at least one degree of freedom.

According to a further preferred embodiment the male unit is a spherical ball and the female unit has an internal spherical surface of substantially the same radius as the ball.

By the spherical arrangement three degrees of freedom can be obtained.

According to a further preferred embodiment a bearing layer is provided between the male unit and the female unit.

Through the bearing layer a low coefficient of friction can be obtained since there will be no direct contact between the basic construction materials of the male and female units. The materials of these units thereby can be chosen without any need to consider their coefficient of friction. This offers greater freedom to select materials based on weight criteria. The lower coefficient of friction also makes it possible to operate with lower actuation forces. The joint attachment to the robot arms or rods can therefore be made with a smaller diameter and still maintain sufficient stiffness. To use a smaller attachment part will make it possible to increase the working range of the joint.

According to a further embodiment the bearing layer comprises a first plastic component attached to the internal surface of the first socket part and a second plastic component attached to the internal surface of the second socket part, each of the plastic components having a high Young's module and low friction against metal.

Such a plastic layer can easily be attached to the socket parts of the female unit and will allow the joint to work very effectively, with low resistance and neglectable losses.

According to a further preferred embodiment at least one of the plastic components comprises a flange arranged for fixing the component to the respective socket part.

The flange can be adapted to hook around the edge of the socket part, which normally will be sufficient to maintain the plastic component in place. This will make possible a simple assembly and disassembly of the joint while simultaneously result in a secure attachment to the socket part.

According to a further preferred embodiment the external surface of the male unit and/or the internal surface of the female unit have/has a coating of a high hardness, low friction material.

This is an alternative to provide a separate plastic layer. By a coating of this kind metal-to-metal contact is avoided and the joint will work almost frictionless. By high hardness is meant a hardness higher than 500 HV and by low friction is meant a friction coefficient below 0.1. In many cases it is preferred to apply the coating to the male unit.

According to a further preferred embodiment the material of the coating is diamond like carbon. This material is very suitable for this purpose since the hardness thereof is in the range of 1500 to 3000 HV and its friction coefficient is in the range of 0.08-0.1.

By using a bearing bronze surface either on the male unit or on the female units it is possible to increase the surface area under pressure. This is because of the adaption of the geometry of the softer bronze material to the much harder diamond like carbon material.

According to a further preferred embodiment the coating is evaporated or sputtered onto the surface.

These are application processes that are particularly suitable for the kind of materials that will come in question for the coating and results in a strong coating with a uniform thickness and a very even surface.

According to a further preferred embodiment at least one grease channel is provided, which ends in the external surface of the male unit and/or the internal surface of the female unit.

By supplying grease through this channel or channels the friction within the joint can be still further reduced. The grease channel can preferably be a complement to the bearing layer or in some cases replace such a layer. Preferably the grease channel is provided in the male unit.

According to a further preferred embodiment the male unit is hollow.

This will further reduce the weight of the joint and result in a still higher stiffness to weight ratio.

According to a further preferred embodiment the female unit comprises a slit in which a mounting member for the male unit can be moved.

This arrangement results in a higher mobility of the joint units relative to each other, in particular when a joint of three degrees of freedom is concerned. The slit can be made in either of the socket parts, in only one of them or be formed by a gap between them.

According to a further preferred embodiment the male and/or the female unit are/is made of aluminium.

Using aluminium as material for the joint unit contributes to achieve a high stiffness to weight ratio for the joint.

The present invention also relates to a joint assembly that comprises two or three joints according to the invention.

By such an assembly a joint having three degrees of freedom can be formed by combining simpler one degree of freedom joints with each other. Such a construction might in some cases be more convenient than a single three degrees of freedom joint. Furthermore, it is easy to obtain a larger working range with such a joint assembly.

The present invention also relates to a parallel kinematics robot comprising at least one joint according to the invention.

For an industrial robot of this kind it is essential to minimize the weight of the moving parts but maintain a sufficient stiffness for the sake of precision. The advantages gained by the invented joint thereby are particularly important in such a robot.

The invention will be explained more in detail by the following detailed description of some examples of the invention.

### BRIEF DESCRIPTION OF THE DRAWINGS

FIG. 1 is a schematic perspective view of a part of a parallel kinematics robot with joints according to the invention.

FIG. 2 is a section through a joint according to an example of the invention.

FIG. 3 is a section through a joint according to a further example of the invention.

FIG. 4 is a section along line IV-VI in FIG. 3.

FIG. 5 is a joint assembly according to an example of the invention.

FIG. 6 is a section along line VI-VI in FIG. 5.

FIG. 7 is a section through a joint according to a still further example.

FIG. 8 is a perspective view through a part of a joint according to a still further example.

FIG. 9 is a section through a first plane of the joint in FIG. 8.

FIG. 10 is a section through a second plane of the joint in FIG. 8.

FIG. 11 is a schematic side view of a joint assembly with joints according to the invention.

FIG. 12 illustrates a detail of FIG. 11.

FIG. 13 is a section along line XIII-XIII in FIG. 12.

FIG. 14 is a perspective view through a part of a joint according to a still further example.

FIG. 15 is a section through a first plane of the joint in FIG. 14.

FIG. 16 is a section through a second plane of the joint in FIG. 14.

FIG. 17 is a side view of a joint according to a still further example.

FIG. 18 is a section through a part of a joint according to a still further example.

FIG. 19 is a section through a part of a joint according to a still further example.

FIG. 20 is a section through a part of a joint according to a still further example.

### DETAILED DESCRIPTION OF THE INVENTION

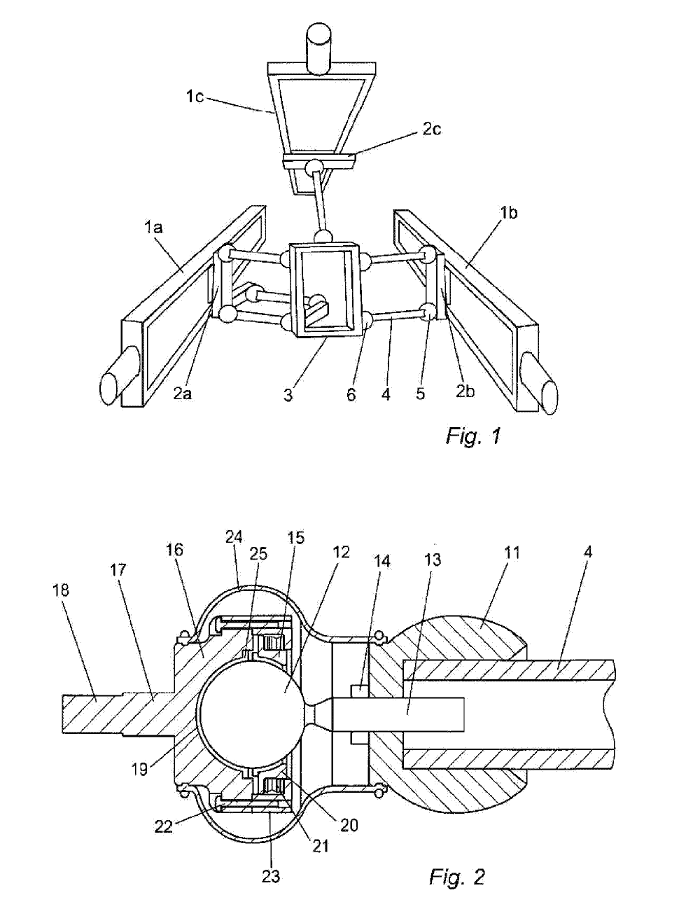

FIG. 1 schematically illustrates a parallel kinematic robot with six links, where the links transmit forces between actuators and a platform. Three linear actuators 1a, b and c move three carts 2a, b and c along three linear guide ways. The carts are connected to a platform 3 via links with joints in each end. Each link consists of a rod 4, of which one joint 5 connects it to the cart 2b and another joint 6 connects it to the platform 3. Both joints can have three degrees of freedom in this link configuration of the parallel kinematics robot. However it will work also with two degrees of freedom for each joint even if the link assembly then will be over constrained, which can lead to the introduction of residual torques in the links. Often a design with three degrees of freedom joints at the cart side is used and with two degrees of freedom joints at the platform side.

FIG. 2 shows a new link design with joints according to the invention. The link consists of a carbon tube 4, and equal joints in each end, of which only one is illustrated in the figure. The link is glued into a spherical link holder 11, which can be made of aluminium. In this holder a spherical ball 12 of aluminium is screwed using the screw thread pin 13, and a bolt 14 is used to fix the position of the ball relative the tube. In this way the length of the link can be accurately tuned, and if the joint or carbon tube is broken it will be easy to exchange the joint. The ball 12 constitutes a male unit and can rotate with three degrees of freedom in the female unit formed by the socket parts 15 and 16 with internal spherical surfaces. Between the socket parts 15, 16 and the ball 12 there are plastic layers, which have very low friction relative the ball. These layers consist of stiff spherically formed plastic components 19 and 20. Each of the plastic components 19, 20 is provided with a flange for securing these to the respective socket part 16, 15, by having the flanges hooking the edges of these. The socket parts 15 and 16 are pre stressed by a spring 21 which is mounted between a spring retainer 23 and the right socket part 15. The spring retainer 23 is fixed to the left socket part 16 by screws 22. The left socket part 16 can be mounted on a carriage (2b in FIG. 1) of a linear actuator or in the actuated platform (3 in FIG. 1) by means of the plug 17, which has a screw thread part 18. Detail 24 is a shield for the joint and made of elastic rubber or plastics to be able to allow the angular movements of the joint.

The right socket part 15 serves also the function of being a thrust washer for the spring 21. The spring 21 might be a flat wire compression spring or a ring manufactured from rubber or plastics and is clamped between the right socket part 15 and the spring retainer 23.

The plastic layers 19, 20 forming the sliding surfaces of the joint are made from Etralyte TX. (Trademark)

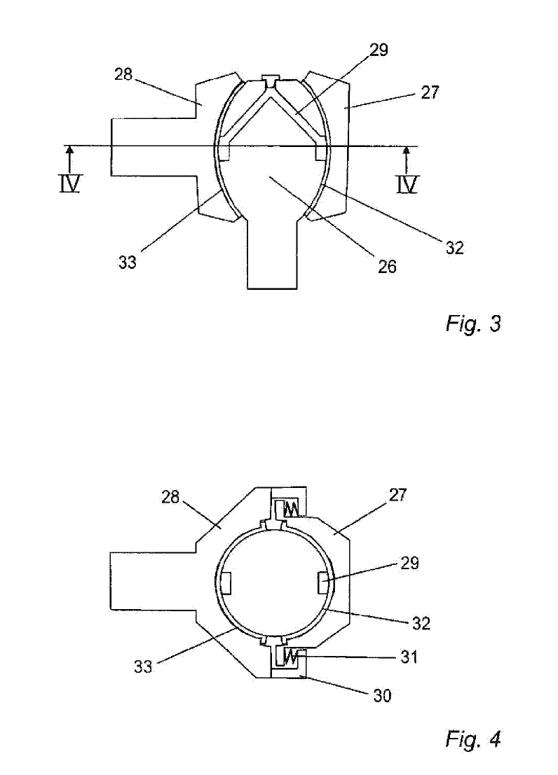

FIG. 3 illustrates a second example of a joint according to the invention. In this case the male unit 26 has an elliptical shape in a cross section in the plane illustrated in FIG. 3. In a plane perpendicular thereof the shape is circular as can be seen in FIG. 4. The two socket parts 27, 28 have a corresponding internal shape as well as the plastic components 32, 33 acting as a plastic bearing. Also in this example a spring arrangement 31 is provided between one of the socket parts 27 and a spring retainer 30 screwed onto the other socket part 28.

In this example the male part 26 is provided with channels 29 ending in the surface thereof. These channels are provided for supplying grease to lower the friction between the plastic components 32, 33 and the aluminium of the male unit 26. It should be understood that corresponding grease channels can be provided also in the other examples. The joint depicted in FIGS. 3 and 4 has one degree of freedom.

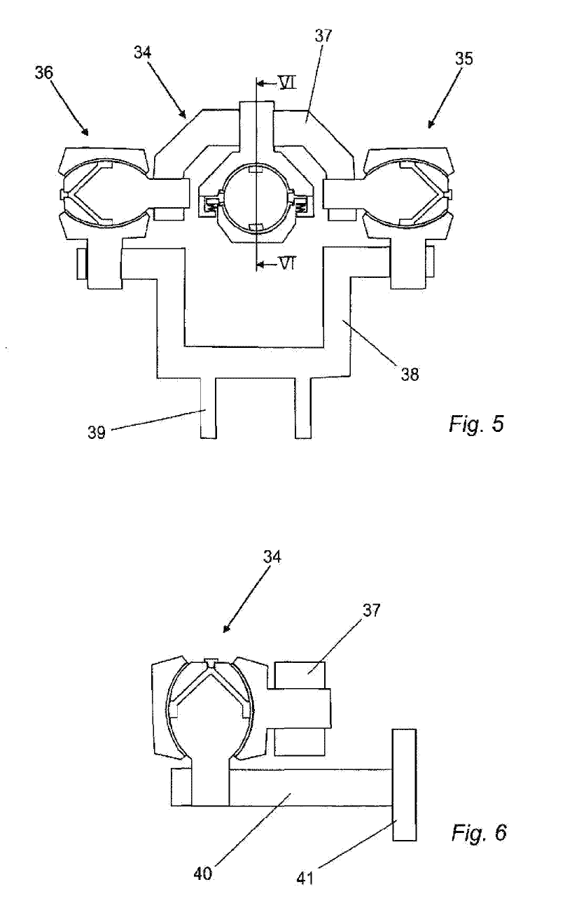

The high stiffness and lightweight joint of FIGS. 3 and 4 can be used to build a two or three degrees of freedom joint arrangement with large working range, i.e. large angles. Such a joint arrangement is illustrated in FIGS. 5 and 6. A first joint 34 gives the first axis and the other two joints 35, 36 form together the second axis, which is perpendicular to the first axis. In FIG. 6 the mounting of the first axis with a beam 40 on a component 41, which can be a platform 3 or a carriage 2 (FIG. 1), can be seen. The joints 35, 36 are mounted on the first joint 34 by a first bridge 37. The holder 39 for the link tube is mounted on the joints 35, 36 by mean of a second bridge 38. All three joints 34, 35, 36 are of the kind illustrated in FIGS. 3 and 4.

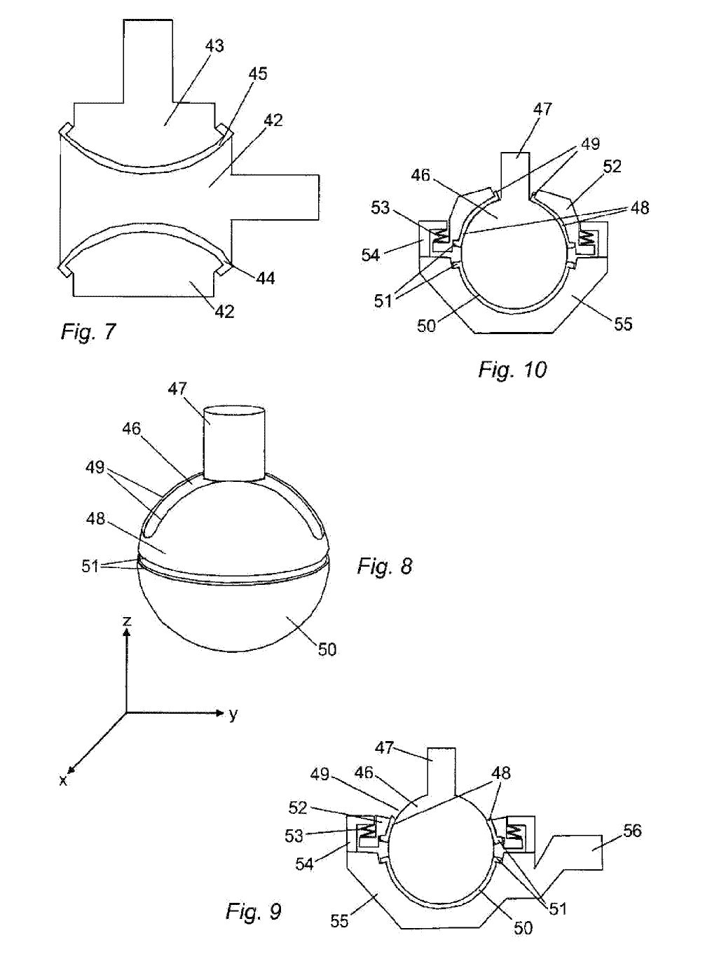

FIG. 7 depicts a second example of a one degree of freedom joint according to the invention. In this case the male unit has a concave cross section in a plane through its axis. In a plane perpendicular to this axis the cross section is circular. The socket parts 42, 43 of the female unit thus have corresponding concave shapes in the plane through the axis of the male unit 40, and the plastic components 44, 45 are shaped accordingly.

Another possibility to obtain a larger working range joint is shown if FIGS. 8 to 10. FIG. 8 shows the spherical ball 46 used and the mounting plug 47 of this. The lower plastic component 50 is a half sphere and the upper plastic component 48 is a half sphere with a slit 49 in which the mounting plug 47 can move. Of course the plastic component can be replaced by having a low friction surface on either the male unit or the female units, for example by using Diamond Like Carbon. Between the half spheres there is a gap 51. On the plastic components 48, 50 the two socket parts of the female unit are mounted pre stressed together as shown in FIGS. 9 and 10. FIG. 9 shows a section in the yz-plane, in which the slit 49 is located. The socket part 55 is mounted on the link with the plug 56, which is located on this socket part 55 in such a way that the forces will go towards the centre of the ball 46. Between the lower socket part 55 and the ball 46 the plastic component 50 is located. 54 is the spring retainer, 53 the compression spring and 52 the thrust-washer or upper socket part. As can be seen in FIG. 9 the upper socket part 52 is small in this cut since the slit for the swinging of the plug 47 is located in this cut. However, in the xz-cut in FIG. 10 the upper socket part 52 covers a much larger area, which will help to make the joint very stiff. This ball and socket joint will get infinite work space around its z-axis, about +/−50 degrees around its x-axis and dependent on the width of the slit about +/5 degrees around the y-axis. This means that the link should be mounted on the plug 56 while the cart or platform is mounted on the plug 47 of the ball.

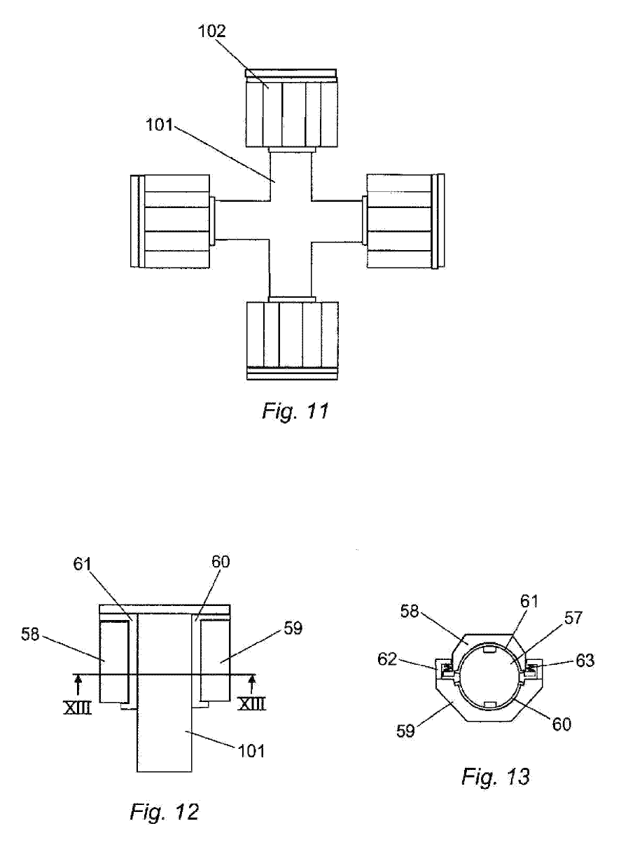

The joint concepts presented in FIGS. 2 to 10 can be used to build a cardan joint with a cardan joint cross 101 according to FIG. 11. Here four joints 102 are mounted on each end of the cross 101. Beside using the joint types in FIGS. 2-10 it is then also possible to use four joints of the type shown in FIGS. 12 and 13. Here the male unit 101 is a cylinder and the socket parts 58 and 59 are clamped using the spring retainer 62 and the spring 63. In this case the spring retainer as well as the springs are straight and not circular or elliptical. Between the socket parts 58, 59 and the male unit 101 are as before plastic components 61, 60.

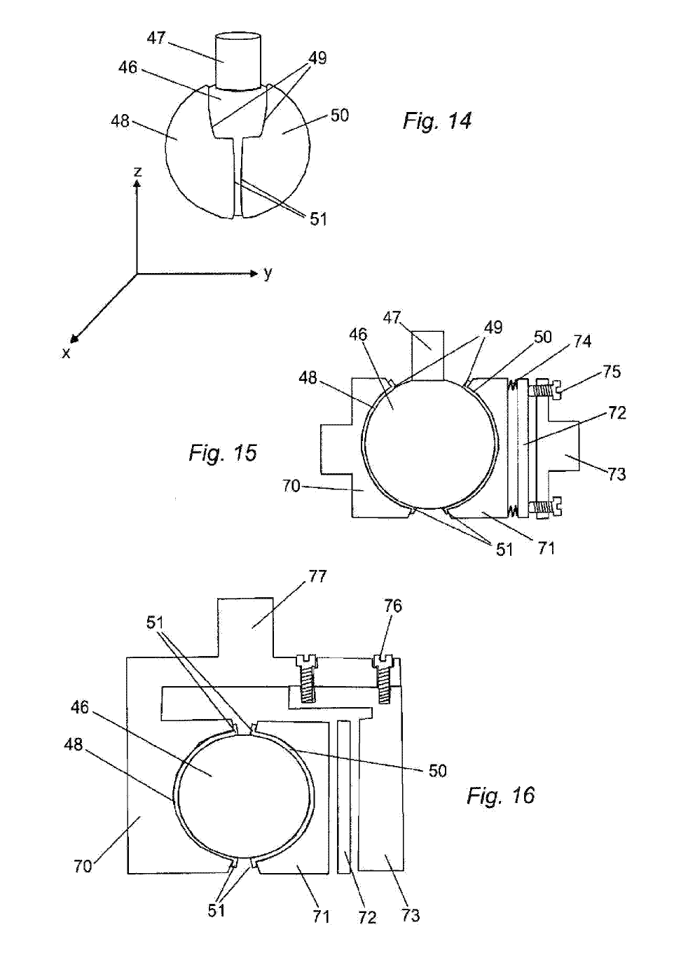

FIG. 14 is a variant of FIG. 8 but with the possibility to obtain an even larger working range in one of the degrees of freedoms on the cost of somewhat larger joint assembly. As in FIG. 8 there is a slit 49, in which the ball mounting plug 47 can be moved. In FIG. 8 the slit is located in one of the plastic components 48 and 50, while the slit is located between these in FIG. 14. By having the slit in between the plastic components it will be possible to have a longer slit, giving a larger working range around the y-axis (perpendicular to the z-axis with infinite working range). Actually the slit 49 in FIG. 14 can be all around the ball but since the working range will anyhow be limited by collision between the ball mounting plug 47 and the link mounting part 77 (see FIG. 16), the two plastic components can have a smaller slit 51 at the part of the circumference to increase the bearing surface and thus increase the joint stiffness. As for the design in FIG. 8 also in this case the plastic components can be replaced by treatment of for example the male unit surface with Diamond Like Carbon. In FIG. 15 the clamping of the socket parts 70, 71 is shown in an yz-section. The socket part 70 and a connection part 73 are rigidly connected as can be seen in FIG. 16 and the springs 74 (FIG. 15) are used to obtain the pre stress of the socket part 71 relative the socket part 70. The pre stress is tuned by the screws 75 connecting the connection part 73 with the spring retainer 72. In FIG. 16 a section in the xy-plane is shown with a link rod mounting part 77 connected to the socket part 70 and the connection part 73, in which the screws for tuning the pre stress are located. Screws 76 are provided to be able to mount the joint.

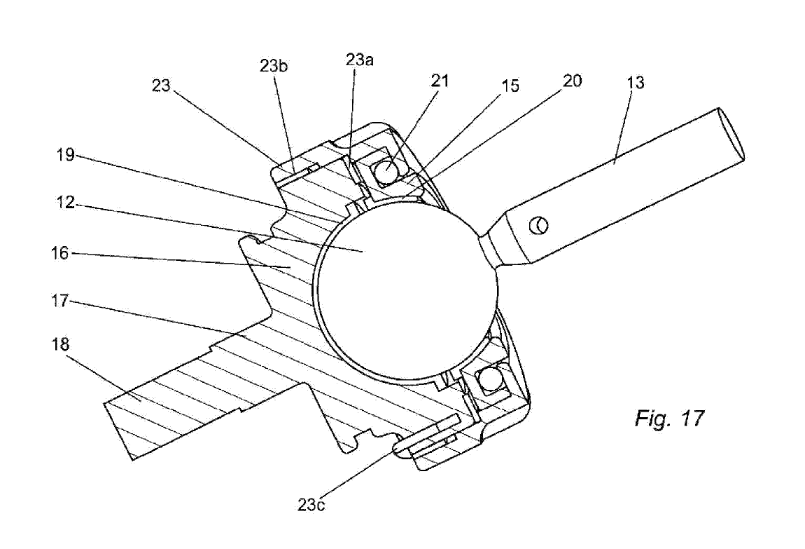

FIG. 17 shows a 3D view of a joint similar to the one shown in FIG. 2. What is different here is the detailed design of the components and that a rubber ring 21 is used instead of a metal spring between the spring retainer 23 and the adjacent socket part 15. This rubber ring is made of a high performance rubber or plastic material which will not change its elasticity with aging. In the example of FIG. 17 the connection between the socket part 16 and the spring retainer 23 is obtained in that the spring retainer 23 has an external thread and the socket part 16 has a matching internal thread, thereby providing a thread joint 23b. A plug 23c is provided in the socket part 16 for locking the thread joint 23b. A shim 23a is provided between the spring retainer 23 in order to define the pre stress.

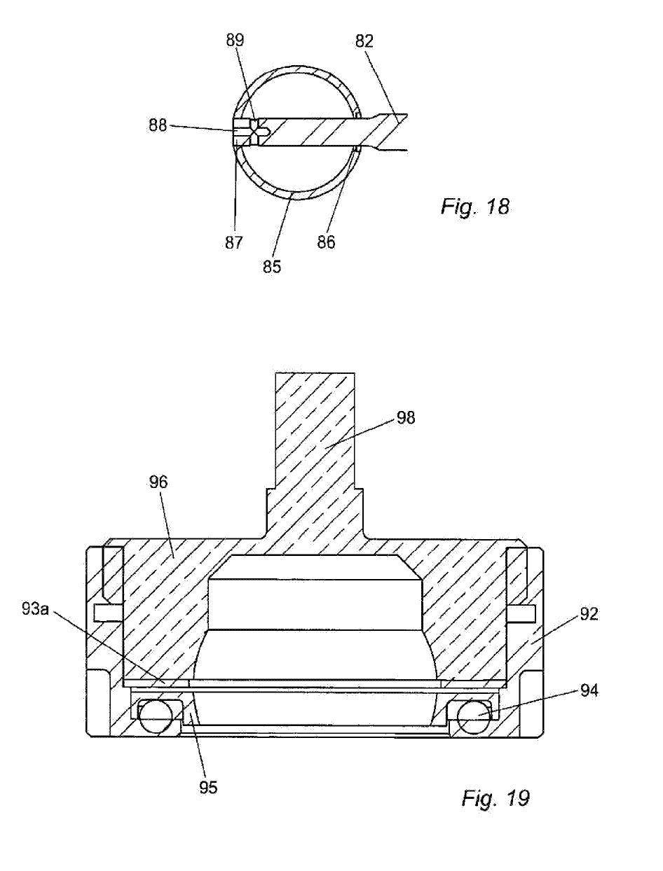

In order to minimize the weight of the joint without reducing the high stiffness, a hollow ball can be used as shown in FIG. 18. The ball 85 has two diametrically located holes 86, 87 in which the pin 82 is welded. The end of the pin has an axial channel 88 and a radial channel 89, which communicate with each other in order to establish air communication with the inside of the ball 85.

FIG. 19 shows the female unit of a joint without a plastic layer but instead with Diamond Like Carbon surfaces to reduce friction between the ball and the socket. Preferably the ball is covered by the low friction material which is evaporated or sputtered onto the ball surface. The socket parts can then be of for example steel or bronze. In order to minimize the weight most of the female unit 96 can still be made of aluminium by making a bearing insert of steel or bronze in the aluminium component. Since a metal to metal bearing will have higher stiffness than a metal to plastic bearing the bearing surface area can be reduced, making it possible to increase the working range of the joint. Beside that no plastic layer is needed in the joint type in FIG. 19, the design principle is the same as in FIG. 17. A spring retainer 92 is screwed on the upper socket part 96, whereby a pre stress force is applied on the rubber ring 94, which in turn pushes the lower socket part 95 against the socket part 96 via the spherical male unit.

When metal to metal bearing technique is used one of the best surface treatment is to cover the ball surface with a DLC (Diamond Like Carbon), which can have a hardness of 1500 to 3000 HV and a friction coefficient as low as 0.08. Beside a hard and low friction ball surface it is also important to have a very small shape error of the ball, which is obtained for example by using bearing balls. If the two socket parts are made by steel (for example SS2260 steel cured to 56-58 HRC), the machining of these must be made with the same low shape error as the ball. An alternative is to use a softer material that will adapt to the shape accuracy of the ball, for example bearing bronze material. It should be emphasized that because of the large surfaces in the joints (compared with ball- or roller bearings) the surface pressure will be low (about 3 MPa in robot with tool forces about 1000 N).

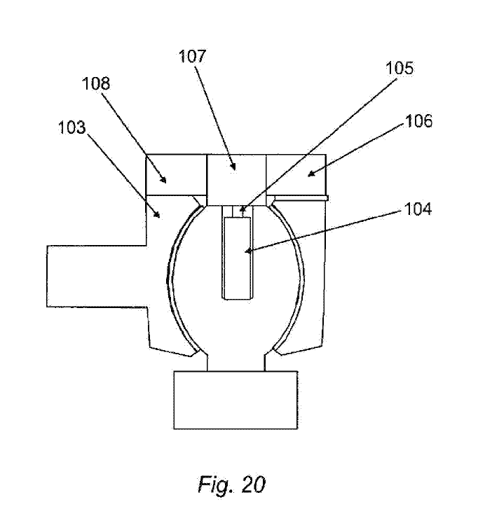

Besides using the described joint concept in a parallel kinematics robot (see FIG. 1) it can also be used in a serial kinematics robot. In this case the joint should only have one degree of freedom to implement the swinging of a robot arm. Then one possibility is to connect two spherical joints of three degrees of freedoms and another possibility is to use a single joint according to FIGS. 3 and 4. It is then also possible to integrate a rotating actuator into the joint as shown in FIG. 20. Here the joint is mounted in such a way that the upper robot arm 99 can swing relative the lower robot arm 100 (swinging perpendicular to the plane of the drawing). The male unit 110 is mounted on the lower robot arm 100 and in the male unit 110 there is a motor 104 driving a speed reducer 106 via a shaft 105. For efficient cooling of the motor this is in thermal contact with the male unit 101. The male unit is connected to the primary side 107 of the speed reducer and the secondary side 108 of the speed reducer is attached to the upper arm 99. The upper arm 99 is mounted on the female unit 103 and as earlier shown in FIG. 4 the female unit 111 is connected to the female unit 103 by means of the spring 31 and the spring retainer 30.

1. A parallel kinematics robot comprising joints, at least one of the joints comprising a male unit, and a female unit, the external surface of the male unit being of complementary shape to the internal surface of the female unit for cooperation therewith and having a shape allowing rotational movement in at least one degree of freedom of the male unit within the female unit, the female unit comprising at least two socket parts and a biasing means is provided for biasing each of the socket parts towards the male unit, said at least one of the Joints further having a solid bearing layer provided between the male unit and the female unit.

2. The robot according to claim 1 wherein the biasing means comprises a mechanical spring arrangement.

3. The robot according to claim 2 wherein the spring arrangement is acting between a spring retainer device and a first of said socket parts, the spring retainer device being connected to the second socket part.

4. The robot according to claim 3 wherein the spring retainer device is connected to the second socket part by a screw join.

5. The robot according to claim 4 wherein the screw joint includes an external thread on one of the socket parts and a matching internal thread on the other socket part.

6. The robot according to claim 4 further comprising a shim located between the spring retainer device and the second socket part.

7. The robot according to claim 2 wherein the first socket part acts as a thrust washer for the spring arrangement.

8. The robot according to claim 1 wherein the male unit has a rotation symmetrical external surface witch is generated by a curved line.

9. The robot according to claim 8 wherein the male unit is a spherical ball and the female unit has an internal spherical surface of substantially the same radius as the ball.

10. The robot according to claim 1 wherein the bearing layer comprises a first plastic component attached to an internal surface of the first socket part and a second plastic component attached to an internal surface of the second socket part, each of said plastic components having a high Young's module and a low friction against metal.

11. The robot according to claim 10 wherein at least one of the plastic components comprises a flange for fixing the component to the respective socket part.

12. The robot according to claim 1 wherein at least one of an external surface of the male unit and an internal surface of the female unit has a coating of a high hardness low friction material.

13. The robot according to claim 12 wherein the material of the coating is diamond like carbon.

14. The robot according to claim 12 wherein the coating is evaporated or sputtered onto the respective surface.

15. The robot according to claim 1 further comprising at least one grease channel which ends in at least one of an external surface of the male unit and in an internal surface of the female unit.

16. The robot according to claim 1 wherein the male unit is hollow.

17. The robot according to claim 1 wherein the female unit comprises a slit in which a mounting member for the male unit can be moved.

18. The robot according to claim 1 wherein at least one of the male and the female unit are made of aluminium.

19. The robot according to claim 1 wherein the male unit contains an electric motor.

20. The robot according to claim 1, wherein at the robot is a serial kinematics robot.
